(19) United States
(12) Patent Application Publication
(10) Pub. No.: US 2017/0067266 A1
(43) Pub. Date: Mar. 9, 2017

(54) Move up apparatus and method in multi floor construction

(71) Applicant: CAMILO CAUDILLA ALFARERO, Chatsworth, CA (US)

(72) Inventor: CAMILO CAUDILLA ALFARERO, Chatsworth, CA (US)

(21) Appl. No.: 15/330,330

(22) Filed: Sep. 6, 2016

Related U.S. Application Data
(60) Provisional application No. 62/283,644, filed on Sep. 8, 2015.

(51) Int. Cl. E04G 23/06; B66C 1/28; E04G 23/02

(52) U.S. Cl. CPC E04G 23/065; E04G 23/0218; B66C 1/28

(57) ABSTRACT

An engineered structural frames capable of picking, lifting and moving houses or objects. A vertical transport to create a multi storey structure to its maximum height allowed by the building code. The frames are detachables, extendables and expandables to fit pre-determine length, width of buildings or objects. Easy to transport to sites locations because its design to fit a trailer load and no extra length or width to worry about. Can be assembled at jobsite and need a small area to unload delivery on tight spot.

Under development for use in pipeline and cable laying operation or recovery. With special attachments can be use for Environmental clean up works in waterways, rivers and streams. The prime movers for the apparatus are mobile cranes equipt with leveling and weight gauges to determine load capacity.

### REFERENCE PRIOR ART RELEVANT APPLICATION

| | | | |
|---|---|---|---|
| References: | U.S. Pat. No. 4,467,785 | Aug. 28, 1984 | Busby, R. |
| | U.S. Pat. No. 6,481,165 B1 | Nov. 19, 2002 | Romary, E |

US Classification: U.S. Pat. No. 52/741; 66, 122.1, 79.1, 143, 148,23, 146, 157

### FEDERALLY SPONSORED RESEARCH

None

### BACKGROUND OF THE INVENTION

The present invention relates to new method of moving up an entire house or building. Employing current invention, an engineered pick up and lifting assembly apparatus and supporting devices.

The end product results and benefits of current invention will be reflected in millions of existing older houses or dwellings getting an innovation by a process as revealed in this application.

This current invention will generate millions of jobs nationwide in the home innovation sector and revive economic activities in the construction industry.

Implementing current invention will results in increase or double the floor area of existing house by moving to temporary relocation with in property. Build on vacated lot similar size new house walls and partitions only on concrete slab. When desired improvements are done. A mobile Crane to lift up the older house to move over on top of newly built first floor. A mix newly built two story house, when final completion look new includes ground works.

Innovation projects will provide local and state government increase real estate assessment and results in increase in real estate taxes.

The success of implementation current invention is possible with the help of the building supporting devices incorporated as part of the invention which give strength & stability of the structure in the move up operation. Also current invention provide update of old house to new building code. Significant in providing house protection for storm-seismic activities and roof also wall stability. The devices added will make the house stronger and provide longer life span to the building.

Prior Art mentioned about prefabricated or manufactured homes transport problems resolved. Another talks about adding a room in the second floor of a house. This is a complex problems that accomplish little. The current invention addresses more beneficial issues that will result in converting old houses to new uses. Provide more values and productivity to the properties.

### BRIEF SUMMARY OF INVENTION

To describe briefly in accordance with Apparatus Embodiments. The embodiment with sliding adjustable joint is adoptable for smaller houses or buildings. Whereas the apparatus with the expandable and extendable embodiment is adoptable for heavier and larger houses or buildings. Other apparatus configuration can be set up using combinations of both embodiments as shown on FIG. 8 item # 17 a frame joint connector device.

Configuration on FIG. 8 item # 17 called Multi Unit joint Connection can be modified with their corresponding attachments to be used in Pipeline or Cable laying operations. Also it can be use with modified attachments in Environmental Clean up operations in waterways; rivers and streams other recovery operations.

### BRIEF DESCRIPTION OF THE DRAWINGS

There are eight drawing sheets submitted:

FIG. 1 Perspective view of the sliding Joint frame embodiments

FIG. 2 Perspective view of expandable and extendable frame embodiments

FIG. 3 Detail drawings of sliding joint connections item # 2 element holds the pick up points for lifting the house and serve to join and hold together the frames.

FIG. 4 Plot plan of standard California residential size property 50 feet×100 feet it shows 20 feet set back building line. Show position of lifting Crane at front yard and a parking layout for 6 cars at back yard; 2 cars item #51, 4 compact cars item # 52. Showing also temporary relocated old house item # 53

FIG. 5 Plot plan for standard lot like FIG. 4. Showing 40 feet set back line and position of Crane at back yard with layout for 5 cars parking; 2 at front item #69, 3 compact cars back yard item # 66. Show temporary location of old house item # 56 at front yard.

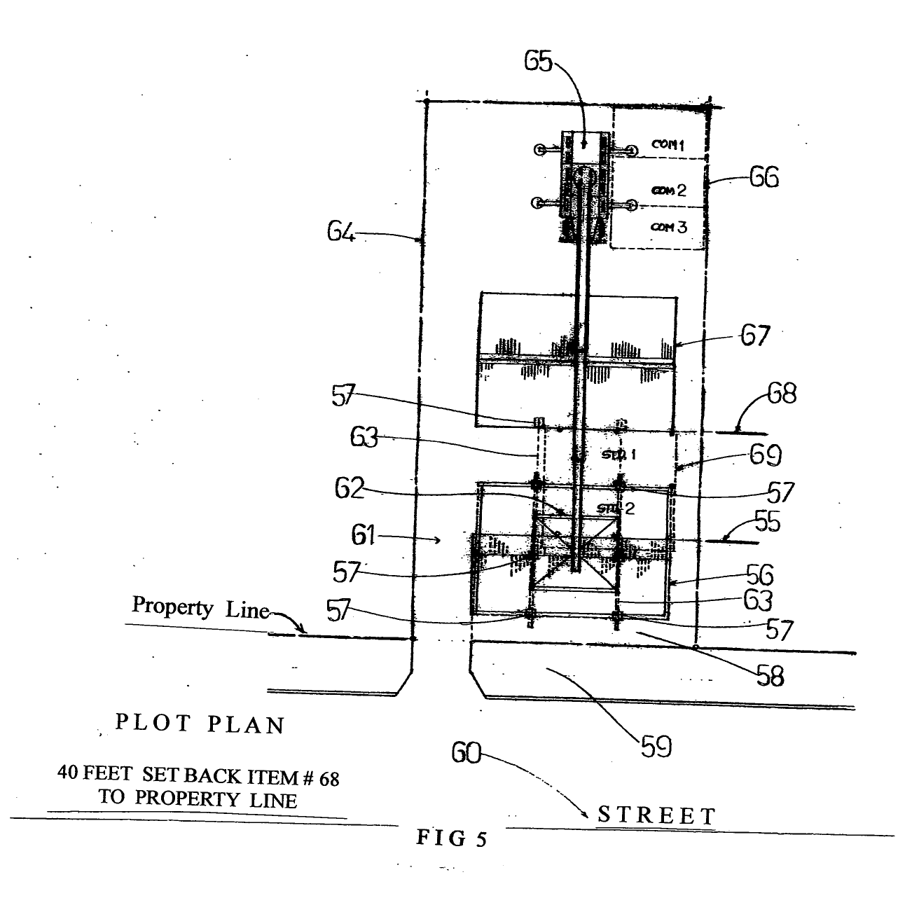

FIG. 6 Side view of extendable and expandable frame members items #29 & #32, showing also joist-girder and floor supports details items #37, # 39, #40, #43 & #27.

FIG. 7 Plan view corner metal bracket item # 9 & item #10 and section details of both. Its showing also details of item # 6 metal wire mesh (prior art) serves as lifting harness. Metal brackets serves to hold house from movement during move up operation and serves also to secure item # 7 beam from movement.

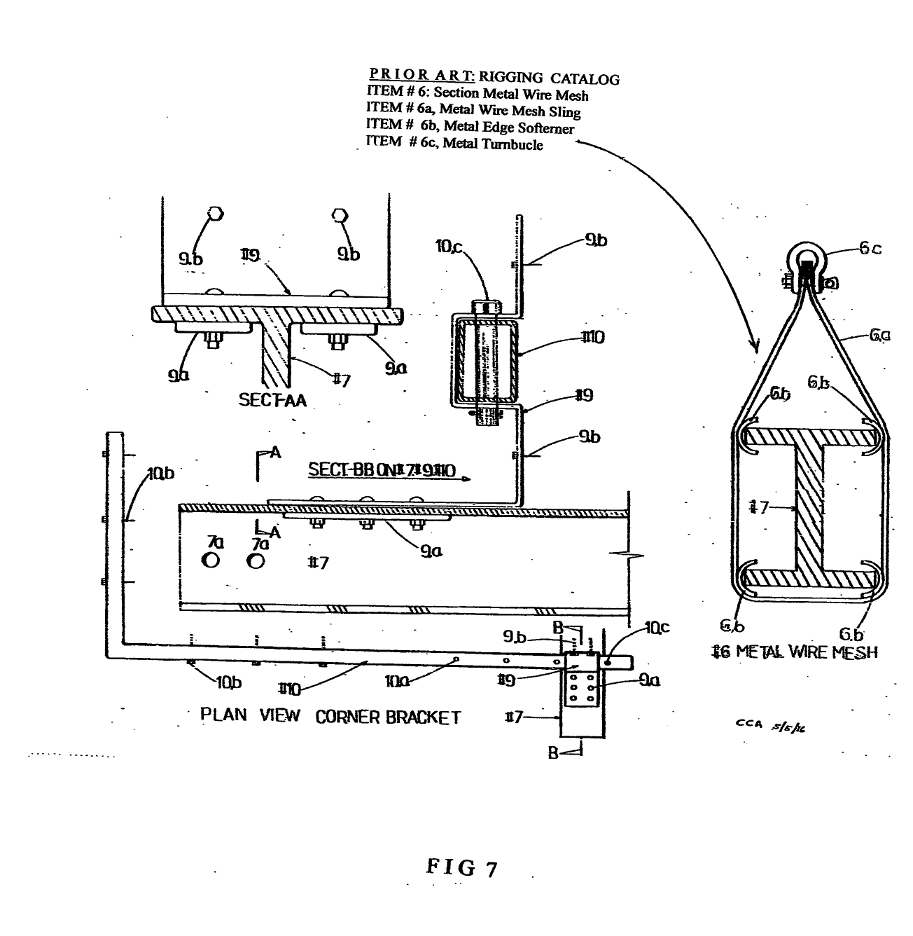

FIG. 8 Plan views of; rafter-ridge metal tie down item #11, footing anchor metal guide item # 21, wall hold down item # 16 and item # 17 a combination for multi unit connection for longer or appropriate objects operations, like pipeline & cable laying operation. It can be modified to reconfigure for environmental clean up and recovery for waterways, rivers and streams.

### DETAILED DESCRIPTION OF THE INVENTION

Consists of (4) Frames and Supporting Devices

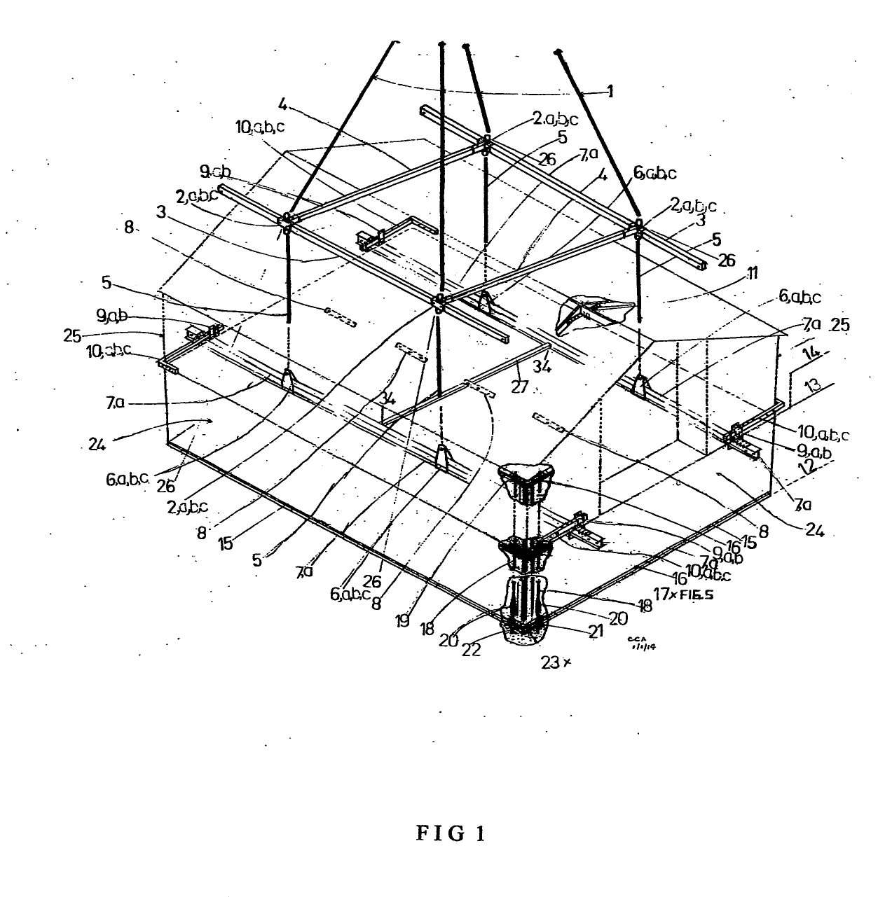

FIG. 1 is showing a pick up frame consists of beams item #3 and item # 4 and a sliding joint connector item # 2 that holds the frame together with hooks at pick up pointing upwards together with cables #1 to tie to the mobile Crane boom. The connector is capable of sliding and braking at pre-determine spot to fit & secure the house to be move up.

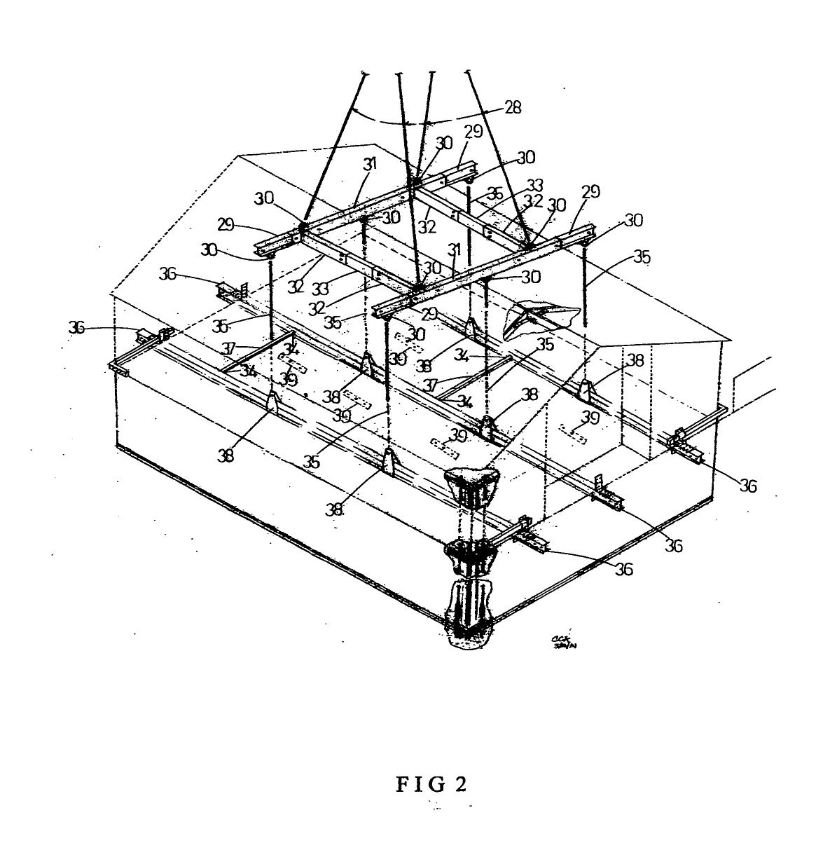

FIG. 2 Another pick up frame consists of extendable & expandable beams item # 29, items # 32 and item # 31 with multiple hook up points items # 30 both frame members.

Beam item #33 has two pin holes to coincide with pin holes at item beam # 32 pins serves locking device to hold beams. At beam item # 29 are provided with downward hooks. At beam item # 31 has two hooks pointing upward serves as pick up points for the frame to meet cables going to the Crane boom hook up.

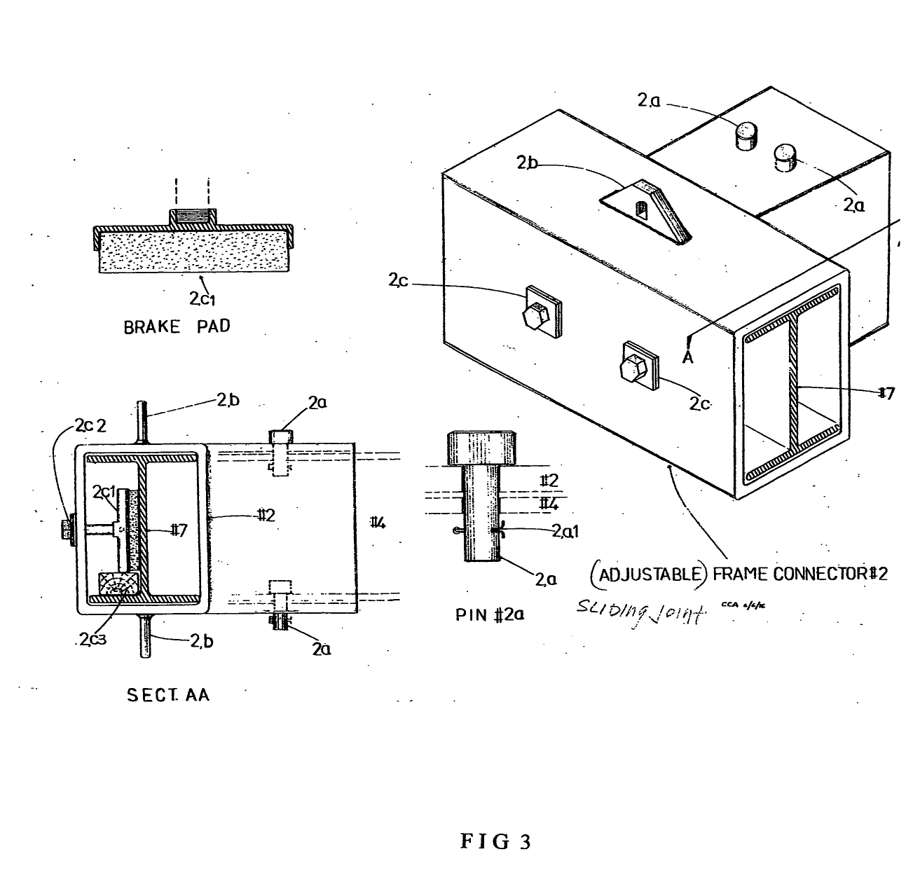

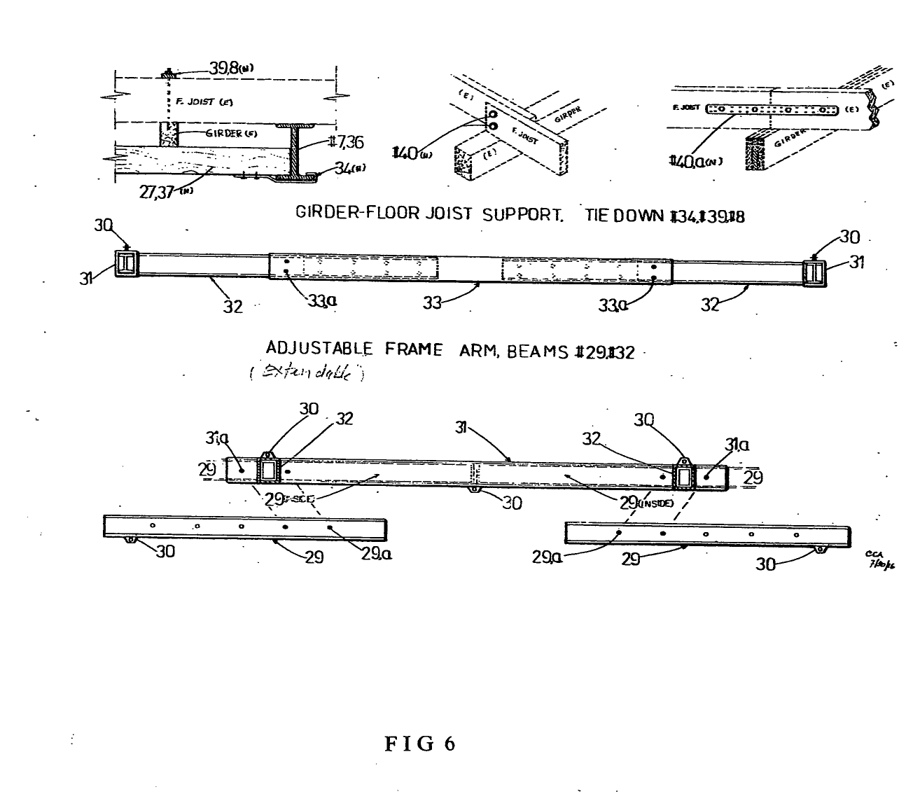

FIG. 3 Lifting frames serves both FIG. 1 & FIG. 2 in different capacities, Lifting frame FIG. 1 consists of beam items # 7 & beam item # 27 and indirectly metal corner bracket item # 10 & item # 9 the two serve well in the stability during move up operation by securing house from movement and collapse during the move up operations. Lifting elements are served by item # 6 the metal wire mesh harness that provide cable attachment to tie cable on pick up hooks pointing downward at pick up points at item # 2 the connector. Critical of the lifting operations are the supporting devices on item #27 & item #34 on FIG. 1 and items #37 & items # 34 on FIG. 2 and all multiple locations to supporting the the girders from fulling apart during lifting, they are also supported by items # shown FIG. 6, the Floor-Girder, Floor supports and Tie down items at multiple locations under the house or building for move up operations.

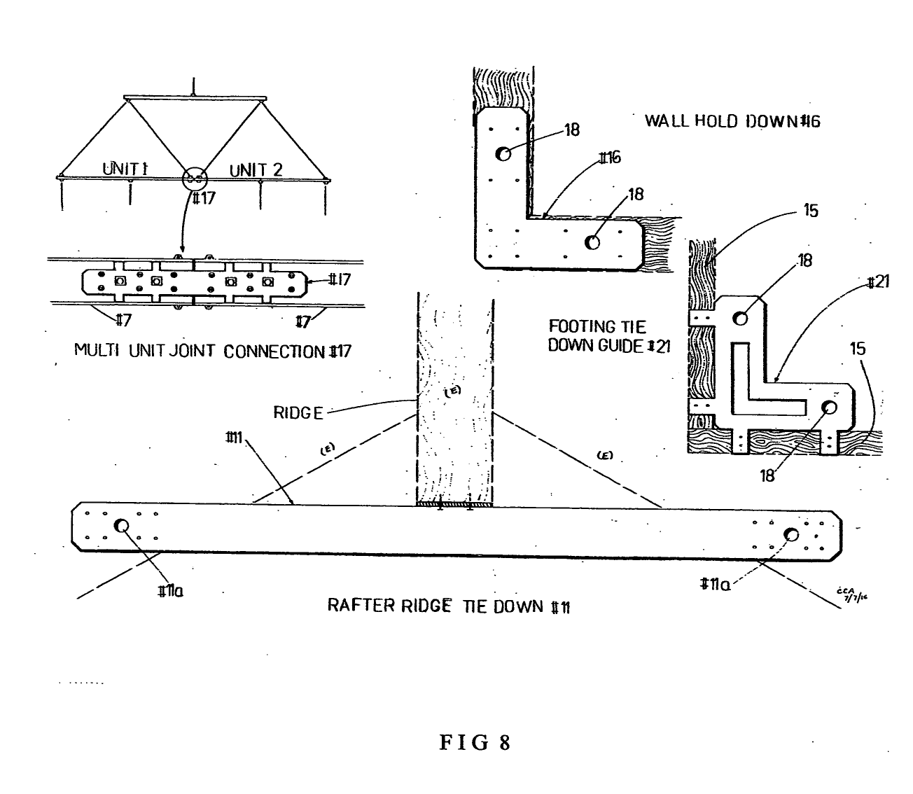

Either embodiments are detachable capable of reconfiguration useful for other pick up lifting objectives. Works underdevelopments to use in pipeline, cable operations and also for environmental clean up operations and recovery. FIG. 8 item #17 Multi unit Joint Connection for current objectives on multiple combination use.

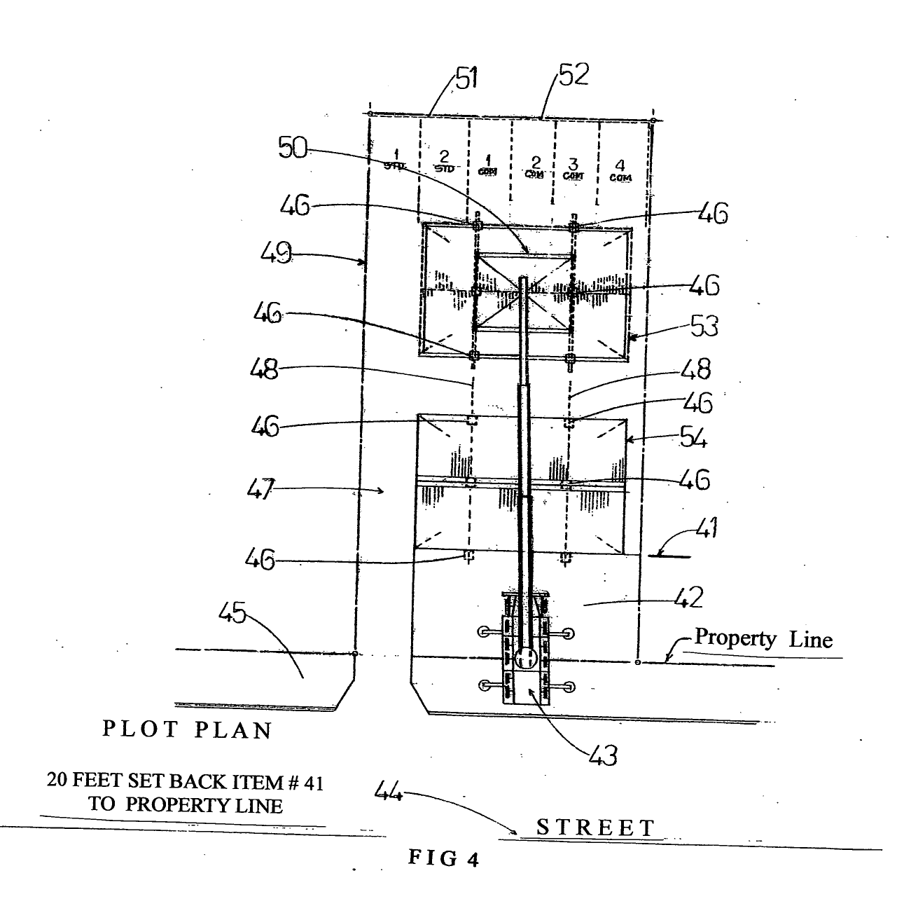

FIG. 4 Storm-Seismic Structural Frame consists of:
a) Wall hold down item #16 FIG. 8 is a metal angle strap with nail holes multiple locations at top and bottom of old building walls, where anchor rods passes through to act as vertical member of the frame. Structural nails use to tie wall and metal rod.
b) Anchor tie rod item # 18 FIG. 8 (prior art) located at corners of building or house. This rods are embedded inside wall frames and runs continues top of the corner of wall.
c) Square metal washer with closing nut, where anchor rods end located at corners top of walls see item # 19 FIG. 1
d) Turnbucle (prior art) item # 20 connecting anchor bolt item #22 metal rod item # 18

All elements, parts and devices associated with lifting operation will conform to the rigging manual of the Crane Institute of America procedure & specifications. Including all Prior Arts mentioned in my application.

1. A structural move up Apparatus
Comprises:
a) A frame
b) A sliding movable element along beam, said element has a braking capabilities.
c) A structural lifting frame having means to tie pick up frame together to move up objects.

2. Another structural move up Apparatus
Comprises:
a) A pick up frame
b) An extentable and expandable element along beams.
c) A lifting multiple beams, having means to tie up pick up frame in single operation

3. A storm seismic frame
Comprises:
a) Dual vertical metal rods
b) A metal rod passes through angular metal plate at multiple locations at walls
c) A joiner element connects metal rod to anchor bolt.
